(19) United States
(12) Patent Application Publication
(10) Pub. No.: US 2012/0068133 A1
(43) Pub. Date: Mar. 22, 2012

(54) Overhead Storage Device

(76) Inventor: Robert Ozarski, Poway, CA (US)

(21) Appl. No.: 13/235,326

(22) Filed: Sep. 16, 2011

Related U.S. Application Data
(60) Provisional application No. 61/403,487, filed on Sep. 16, 2010.

(51) Int. Cl. B66D 1/14; B66D 5/34

(52) U.S. Cl. 254/364

(57) ABSTRACT

An overhead storage device having a lifting range. A constant torque spring is attached to a power pulley and is adapted to apply an approximately constant torque to the power pulley. A cable is partially wound around the power pulley and has an attachment mechanism at one end of the cable. A locking mechanism is adapted to permit the attachment mechanism and an attached load to be lowered and locked at any desired position within the range of the device. The approximately constant torque applied by the constant torque spring continuously causes the cable, unless restrained, to be further wound on the pulley.

### FIELD OF THE INVENTION

This application claims the benefit of Provisional Application 61/403,487 filed Sep. 16, 2010, which is incorporated by reference herein. The present invention relates to storage devices and in particular to overhead storage devices.

### BACKGROUND OF THE INVENTION

Most families in the United States own one or more bicycles. Only a small portion of the populations regularly rides the bicycles. Most bicycles in the United States are in storage, often with flat tires and rusty chains. Many bicycle storage devices have been proposed. Many of these devices seek to store the bicycles in spaces not needed for other uses, such as up above floor spaces, for example, by hanging the bicycle from a ceiling in a garage, above normal automobile spaces. Some prior art patents covering bicycle storage include the following U.S. Pat. Nos.: 3,872,972, 6,161,207, 3,907,113 and 5,183,162. U.S. Pat. No. 3,872,972 includes a rack for hanging a bicycle above the floor and includes a counterweight to ease the effort associated with raising the bicycle.

Prior art U.S. Pat. Nos. 7,370,843 and 7,753,343 disclose a retractable load support system including a constant torque spring for providing an approximately constant torque to a spool arranged to lift a load like a bicycle for overhead storage. The system included a gerotor “for dampening the raising of [the load] in a relatively fast manner which can damage the [load or the support system]. A gerotor is a special fluid pump and in this system the fluid was merely circled to dissipate energy so as to slow down the lifting of the load. The gerotor adds considerably to the cost of the system.

What is needed is a better device for storing bicycle and other items which clutter a garage.

### SUMMARY OF THE INVENTION

The present invention provides an overhead storage device. The device is particularly suited for storing items commonly stored in a garage, such as bicycles, golf clubs, and yard equipment, which occupy floor space and often exclude the ability to park an automobile in the garage. In particular the device includes a mechanism for hoisting the object to be stored such as a bicycle above floor level. The device includes a cable with an attachment mechanism at one end of the cable. The cable is partially wound on a spool. A constant torque spring applies an approximately constant torque to the spool. This approximately constant torque continuously causes the cable, unless restrained, to be further wound on the spool. The device includes a special locking mechanism which allows the attachment mechanism and an attached load to be lowered and locked at any desired position within the range of the device. In preferred embodiments the locking mechanism includes a pawl and ratchet unit adapted to restrain any lifting of the load unless a release cord attached to the pawl (between a pivot axis of the pawl and the ratchet) is pulled downward. The pawl and ratchet unit is preferably designed to require a downward force greater than the typical load to be applied to the release cord in order to pull the cord downward releasing the locking mechanism (if no load (or a relatively light load) is attached to the attachment mechanism. This feature prevents an accidental release of the locking mechanism when no load is attached to the attachment mechanism. Such an accidental release could damage the load and/or the storage device.

Preferred embodiments provide for the storage of two bicycles on two independent pivoting arms, by raising each separately from a standing position on the floor to a position near or at the ceiling or in the case of an open beam and rafter between the joists for storage out of way of persons or objects. The preferred device further allows the bicycles held by the storage device to be positioned by separate pivoting arms for each bicycle in an arc about the central support shaft such that the bikes may be independently positioned at the ceiling against a wall or above other obstacles or a vehicle such as an automobile, truck or SUV for storage in their raised position through the spring and pulley system. The Pivoting arms allow the bicycles to be raised and lowered from a convenient location within an arc around the main support shaft and then pivoted to the desired storage location, which can be above other objects which would otherwise interfere with raising and lowering if the pivoting capability was not present. The main support is accomplished by “pinching the vertical support between the ceiling and the floor to support the load with no load bearing fasteners to the ceiling, floor or walls. A means are also provided to tilt the bicycle horizontally as it is raised to allow it to take less headroom when it is stored.

The lifting mechanism may also be mounted independently of the pivoting arms and support pole in a fixed position. Alternative mounting means are where the lift mechanism is mounted directly to the ceiling rafters or a wall by means of securing bolts and or mounted in a position which straddles the joists, where it is secured by screws or bolts. The invention is not limited to lifting of bicycles. The device allows for other items to be stored, such as golf clubs, yard equipment, etcetera, out of the way, by raising them above floor level.

### BRIEF DESCRIPTION OF THE DRAWINGS

FIGS. 1-3b show a preferred embodiment of the present invention.

FIGS. 4-4b show another preferred embodiment of the present invention.

FIG. 5 shows another preferred embodiment of the present invention.

FIG. 6 shows another preferred embodiment of the present invention.

FIG. 7 shows another preferred embodiment of the present invention.

FIG. 8 shows a preferred bike load hook.

### DETAILED DESCRIPTION OF PREFERRED EMBODIMENTS

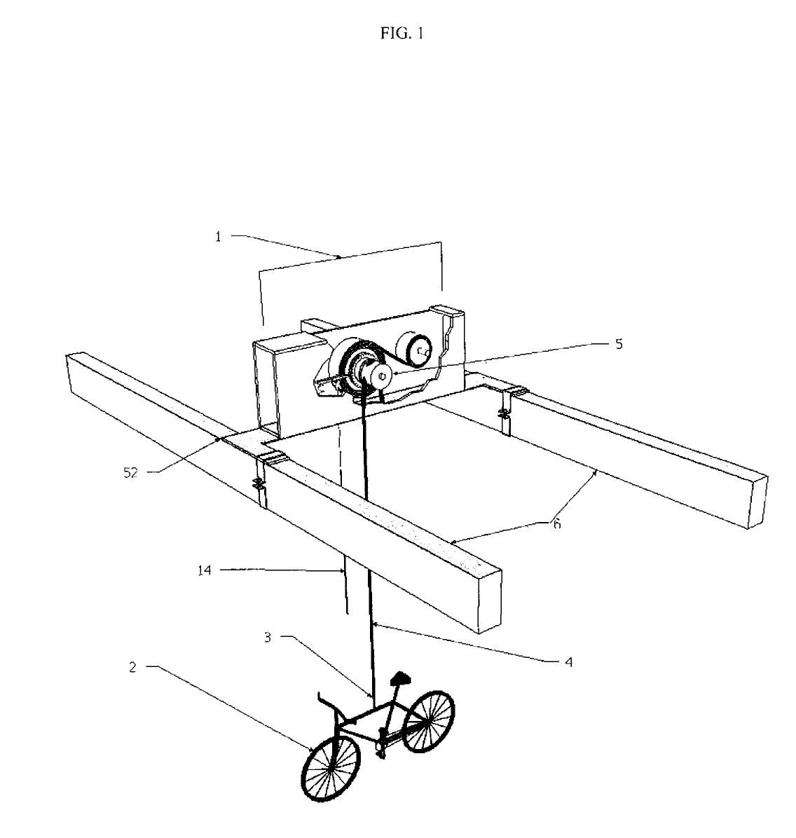

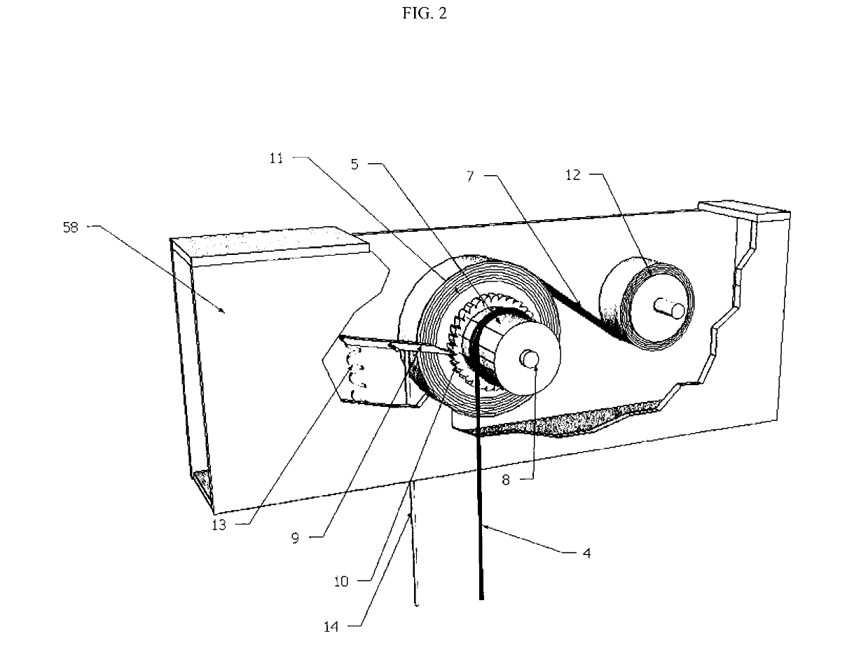

FIG. 1 shows a bicycle storage device, which allows a bicycle to be lifted by a constant torque spring mechanism 1 and pulley system 5, from its standing position on the ground to a position at the top of the lifting device's travel for storage. A bicycle 2 or other load is attached by a load hook 3, as shown in FIG. 1 to a lift cable 4 suspended by the device's power pulley 5 which is attached to containment box 58 through a shaft 8, shown in FIG. 2. A constant torque spring 7, supplies a force slightly greater than the weight of the object load (bicycle), such that the load object will rise until the maximum lift height is reached or the object reaches the ceiling. A preferred constant torque spring is available from Vulcan Springs, Inc. with offices in Telford, Pa.

The object load (bicycle) is lowered by manually applying a small amount of downward force, by pulling downward on the object attached to the load hook 3. As the object load 2 (a bicycle) of FIG. 1 is lowered the pawl 9 and ratchet 10 mechanism, shown in FIG. 2 allow it to descend by rotating (in this example a counter clockwise rotation) but when the downward pull is stopped the load object will tend to rise due to the torque applied to it by the constant torque spring 7 by turning the power pulley 5 in a clockwise direction this will cause the pawl 9 to engage the ratchet 10 and prevent the power pulley from turning and the load from rising. The pawl 9 is positioned such that an arc from its pivot position with a radius equal to the distance from the pivot to the pawl 10 apex will intersect the circumference of the ratchet teeth, root circle. The position at which the pawl 9 stops the rotation of the ratchet 10 is where the lower intersection of the two circles occurs. This action allows the load to be stopped at any point in its travel, when the downward force applied by the user is stopped. With the pawl 9 engaged into the ratchet 10, the object load, such as a bicycle, can be removed from the load hook 3 of FIG. 1. The load hook 3 remains at whatever height above the floor it was positioned at.

The lift cable 4 is wound around the power pulley 5, as shown in FIG. 2, to which the lift cable 4 is attached and connected by a shaft to the output spool 11 of the constant torque spring 7. The constant torque spring mechanism 1 is comprised of a support structure 1 and a constant torque spring 7, which is wound around two spools. The output spool 11 and the storage spool 12, as shown in FIG. 2, which are supported by their respective axle shafts. A portion of the constant torque spring is coiled about the output spool 11 and a portion about the storage spool 12 in the reverse rotation as shown in FIG. 2. This reversal of the winding from the output spool 11 to the storage spool 12 creates a nearly constant torque on the output spool 11, which is transferred to the power pulley 5 by the connecting axle 8 connected to the power pulley 5. The torque transferred to the power pulley 5 generates a force which tends to wind the lift cable 4 about the power pulley and thereby lift the load of the attached bicycle or other object, within the lifting limits of the torque, which is supplied by the constant torque spring 7.

The spring is designed such that the torque it generates in combination with the size of the output spool produces a force, which is slightly greater than the weight of the intended load (bicycle for example) to be lifted. The maximum lifting capability is determined by the proper choice of the spring parameters, spool diameters and the power pulley's diameter. For a given constant torque spring, the lifting torque and thereby the load lifting capability of the device can be adjusted to suit the intended load by adjusting the diameter of the power pulley 5. This can be accomplished in a variety of ways, for example by replacing the spool with a suitable diameter for the load, by adding or removing a hollow cylindrical sleeve to the base power pulley 5 to increase its diameter, or by winding a material about the spool upon which the lifting cable rides on top of, thereby increasing the effective diameter as experienced by the lifting cable 4. The spring mechanism provides a nearly constant torque independent of the number of turns on the output and storage spools; this creates a nearly constant force on the lift cable, which is always tending to lift the object load.

To lower the load a downward force is applied by the user which overcomes the constant torque spring force applied to the power pulley 5 such that it unwinds the lift cable 4, causing the load to descend. This will wind further turns of the constant torque spring 7 onto the output spool 11 as the load is lowered. In normal operation the constant torque spring 7 is coiled about the storage spool 12 with only a few turns about the output spool 11. As the load is lowered, from its uppermost position, it winds an increasing portion of the constant torque spring 7 about the output spool 11, which supplies torque to the power pulley 5 and thereby provides a force to resist the weight of the object load, attached to the lift cable 4, in affect counter balancing it. During lowering of the load, the pawl 9, is not engaged into the ratchet 10, attached to the power pulley 5. However, when the load reaches the desired height and the downward force applied by the user is released, the pawl 9 will engage a tooth of the ratchet 10 preventing it from turning and thereby any upward travel of the lift cable 4. This allows the load to be lowered to any desired height and removed from the load hook 3, shown in FIG. 1, at any position along its travel.

To raise the load, the pawl 9 is disengaged from its associated ratchet 10 by pulling a release cord 14 attached to it. The action of pulling the release cord 14, overcomes the force of the pawl spring 13 Pulling the cord overcomes the force of pawl spring 13, and also turns ratchet 10 about three degrees (enough to free the active end of pawl 9 from the teeth of ratchet 1. This disengaging pawl 9 allowing the ratchet 10 attached to the output spool 11 to rotate in a direction which causes the load cable 4 to be wound around the power pulley 5, which in turn causes the load to rise. When the load is not attached on the load 3 the release of the pawl 9 is prevented by the force of the torque, which is trying to turn the ratchet mechanism counter to its rotation for lowering a load and thereby holding the pawl 9 against a tooth of the ratchet 10, preventing it, the power pulley 5 and output spool 11 from turning in a counterclockwise direction in FIG. 2. When a load is placed on the load hook 3 it counter balances the force, on the pawl 9, which is tending to keep it engaged into a ratchet 10 tooth, thereby allowing the pawl 9 to be easily disengaged, by pivoting downward, about pawl hinge pin 15, when the release cord 14 is pulled.

### Alternate Release Mechanism

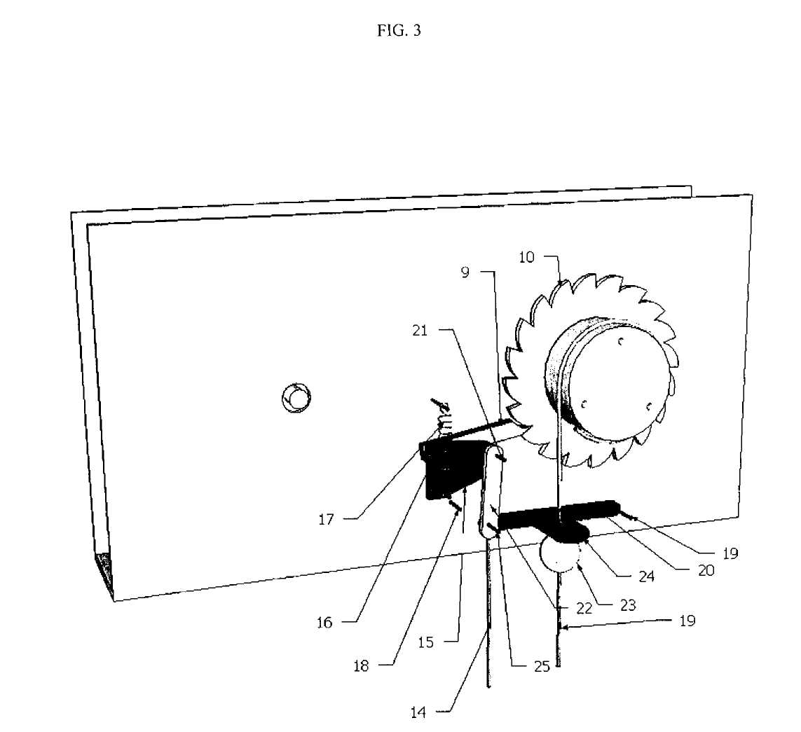

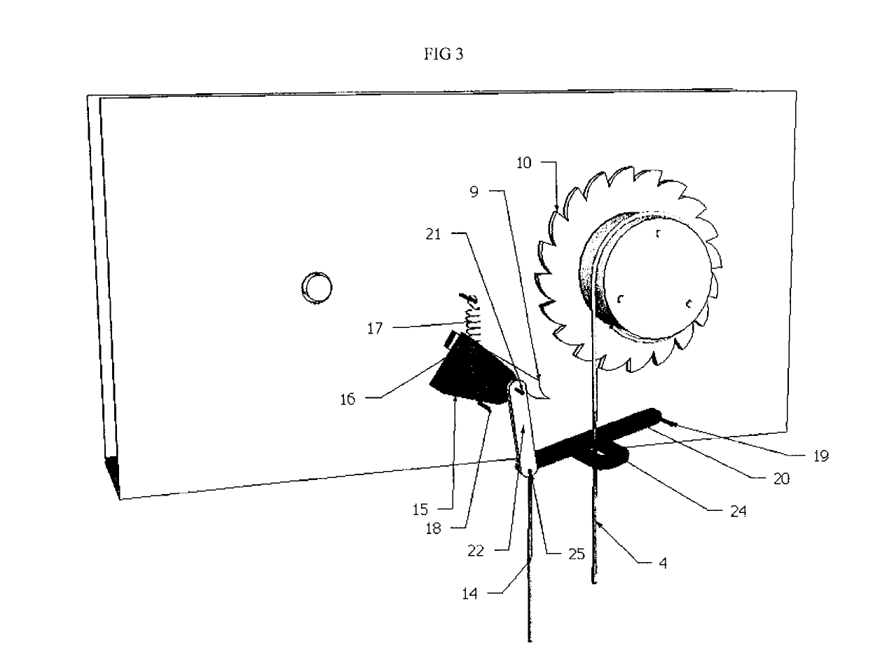

In the above described release mechanism, the release cord must be pulled down during the entire time the load is being raised, in order to keep the pawl 9 from re-engaging the teeth of ratchet 10. This is convenient for stopping the load at any point during its ascension. However it may be inconvenient for some applications to continuously pull the release cord 14 as the load is raised. Therefore, an alternate release mechanism is described in FIG. 3. In this mechanism when the release cord 14 is pulled downward it rotates the cam 15, which is in its up position as shown in FIG. 3a, about hinge pin 16, overcoming the spring force of spring 17, which is tending to rotate the cam 15 counter clockwise. The cam 15 rotates clockwise, until its bottom edge contacts the stop pin 18. The arm 22 and the release lever 20 are also rotated about hinge pins 19, 21, and 25. The lower end of the cam spring 17, will rotate about hinge pin 16. As its lower end rotates clockwise from its position shown in FIG. 3a to the position shown in FIG. 3b, the centerline of the spring moves from the right of the hinge pin 16 about which it pivots, to the left side of the hinge pin 16. Thereby changing the force applied on the cam 15, from tending to rotate it counter clockwise to a force, which tends to rotate it clockwise. Therefore, when the downward pull on the release cord 14 is stopped, the cam 15, arm 22 and release lever 20 will all remain in their downward rotated positions, as shown in FIG. 3b. The pawl 9 remains engaged in the ratchet 10 due to the clockwise rotational force of the constant torque spring 7 of FIG. 2, tending to rotate the ratchet clockwise, as it overcomes the counterclockwise force on the power pulley 5 and ratchet 10 exerted by the load, as shown in FIG. 3b. When the load on the load hook 3 is lowered slightly, by an amount equal to one tooth rotation of the ratchet 10, the pawl 9 will disengage from the ratchet 10 and rotate downward about hinge pin 16 until its lower edge contacts hinge pin 21, stopping its further rotation. The pawl 9 remains disengaged and the load can rise without the release cord 14 being continuously pulled. When the load reaches its raised storage position a sphere 23, shown in FIG. 3b affixed in the appropriate position on the lift cable 4, at a position slightly above the load hook 3, will contact the release loop 24 on the release lever 20, causing it to rotate clockwise, pushing arm 22, upward causing cam 15 to rotate counterclockwise, and thereby rotating pawl 9 counterclockwise until it re-engages a tooth of the ratchet 10. The spring 17 will also have had its lower end rotate counterclockwise, causing the force on the cam 15 to return to a force which tends to turn the cam 15 counterclockwise, thereby holding the pawl 9 against the teeth of ratchet 10, as shown in FIG. 3a. With the pawl re-engaged in the ratchet the load is stopped from rising further and the load is held in the raised storage position, ready to be lowered again.

### Automatic Load Release

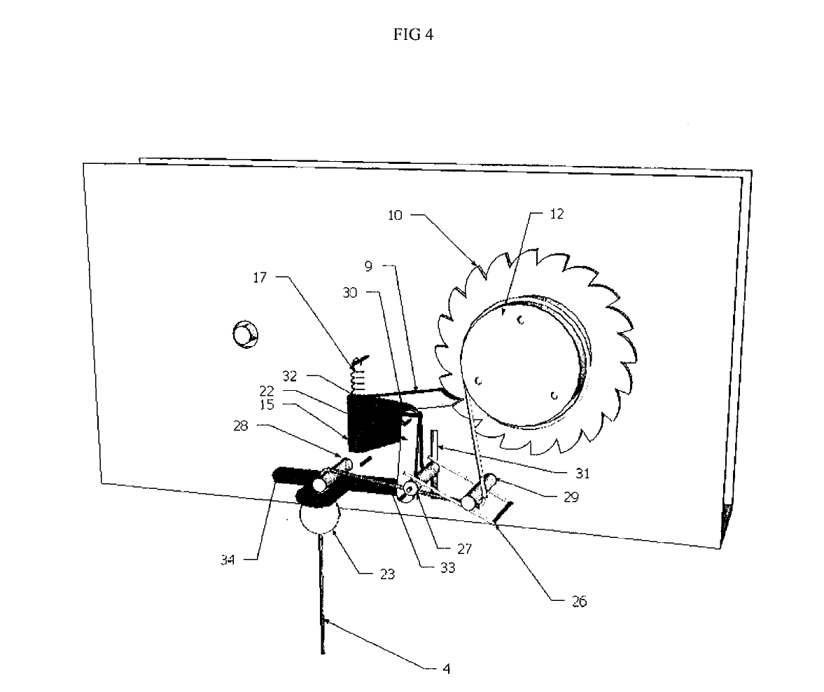

Another alternative for releasing the load eliminates the load release cord 14 entirely. In this alternative the load can be caused to start up to its raised position by putting the load on the load hook 3 and then by pushing the load down slightly, much like the action used to raise a window shade. This mechanism is illustrated in FIG. 4. In operation with the load in its raised position the pawl 9 will be engaged into the ratchet 10 as shown in FIG. 4a. As the load is lowered the pawl 9 is held in place against the ratchet 10 by the cam 15 and the cam spring 17. When the load is lowered and removed from the load hook 3, the load cable 4 will become slack on rollers 28 and 29 and against release roller 27 As Shown in FIG. 4b. This will allow the release spring 26 to overcome the force of the cam spring 17, as it exerts a downward force on the release roller 27 and its attached release wire 30. The release wire 30 engages pin 32 and causes the arm 22 to be pulled downward which rotates the cam 15 clockwise. The cam spring 17 rotates its lower end, such that the cam spring 17 changes the force on the cam 15, which was tending to rotate it counterclockwise to a position, which tends to rotate the cam 15 clockwise. The pawl 9 remains engaged with the ratchet 10 as the force of the torque applied by the constant torque spring 7 tends to rotate it clockwise, thereby causing the pawl 9 to be held engaged with it, stopping further rotation in a clockwise direction. When the load is placed back on the load hook 3, the lift cable will become tight on the rollers 28 and 29 and lift the release roller 27 vertically, constrained by the slot 31 in which the release roller 27 slides in. As the roller 27 is lifted the release spring 26 force is overcome and the release wire 30 rises to a position as shown in FIG. 4a, where it no longer is in contact with the hinge pin 32 on the arm 22. With a load on the load hook 3 a small downward pressure applied to the load, will then cause the ratchet 10 to rotate counter clockwise. This in rotate will allow the pawl 9 to rotate clockwise and disengage from the ratchet 10 until it contacts hinge pin 32 as shown in FIG. 4b. With the pawl 9 disengaged from the ratchet 10. The power pulley 5 can rotate clockwise raising the load, while the pawl 9 continues to be disengaged from the ratchet (10). As the lift cable winds about the power pulley 5 a sphere 23 attached to the lift cable 4 just above the load hook 3 will reach the lift lever 33, shown in FIG. 4a, causing it to pivot about hinge pin 34, which in turn will cause the attached arm 22 to push cam 1 in a counterclockwise rotation, which lifts the pawl 9 in a counterclockwise rotation until it re-engages a tooth on the ratchet 10 causing the rotation to be stopped and thereby the load to be stopped in its raised position as shown in FIG. 4a, ready for the load to be lowered again.

### Centrifugal Clutch:

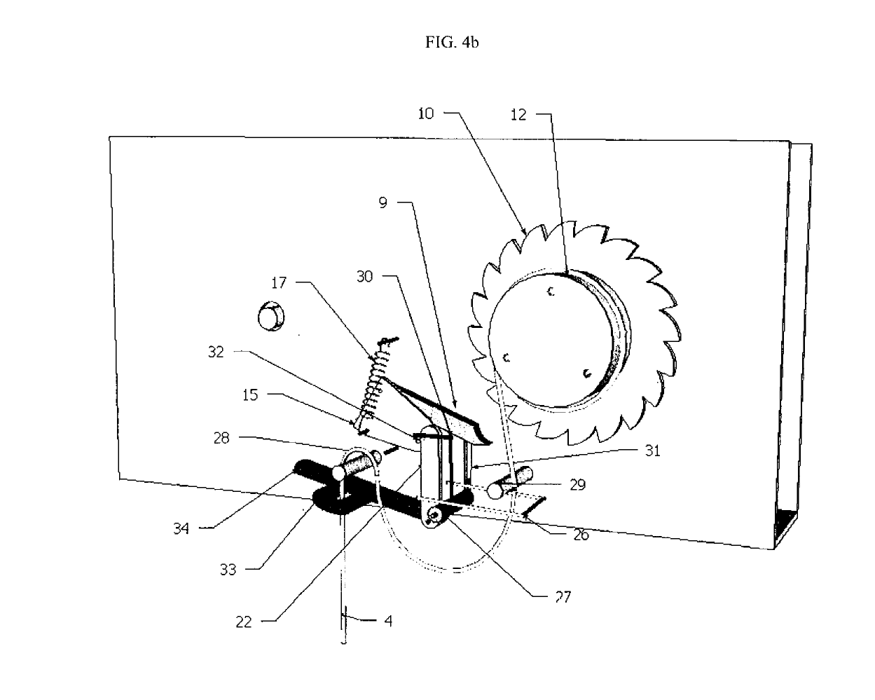

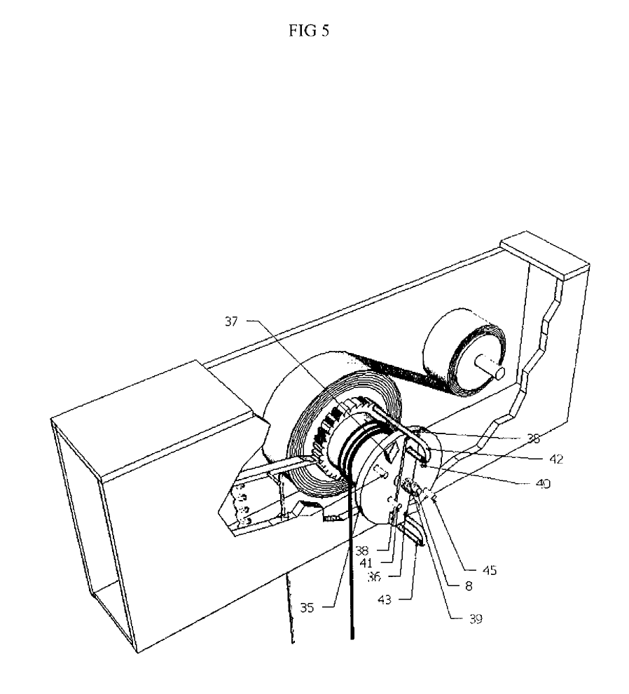

Because the constant force spring in normal operation counter balances the weight of the load it will only cause a gradual rise, when the pawl 9 is disengaged from the ratchet 10. However, an optional attachment may be used to ensure that the power pulley 5 driven by the constant torque spring can not cause a rapid ascent of the load hook 3 if no load is present, such as, if the pawl 9 were to fail or somehow become disengaged from the ratchet 10 when no load is present. Under rapid acceleration the centrifugal clutch as shown in FIG. 5 would engage and stop rotation. The operation of the centrifugal clutch is as follows. A clutch disc 35 attached to the power spool rotates with it. A clutch arm 36 rotates freely about the axel 8 of the power pulley 5. The clutch disc 35 has tapered pads 37 affixed to it at two points as shown in FIG. 5. The clutch arm also has tapered pads 38 affixed to its ends, with the opposite slant as those on the clutch disk 35. A coil spring 39 pushes the clutch arm toward the clutch disk 35 and tends to rotate it counterclockwise such that it rests against the stop pins 40,41, with the tapered pads 37, 38 have there low ends just touching each other, during normal slow rotation of the power pulley 5. If the spool experiences rapid acceleration, the inertia of the clutch arm 36 will tend to prevent it from rotating, while the clutch disk 35 is forced to rotate clockwise, with rapid acceleration. This combined with centrifugal force it will tend to cause the pads of the clutch disk 35 to ride up the pads of the clutch arm 36) causing the distance between the clutch disk 35 and the clutch arm 36 to increase, as the clutch spring 39 force, pushing them together is overcome. As the clutch arm 36 moves away from the clutch disk 35 it can engage the clutch pins 42, 43 which it would normally pass under, at slow rotation, to become engaged with them, which will stop rotation of the clutch disk 35 and the power pulley 5 as the clutch arm 36 becomes wedged against the stop pins 44, 45 and the clutch pins 42, 43. The force of the constant force spring will keep the clutch arm 36 wedged in this locked position after rotation stops. Reversing the rotation by placing a load on the load hook 3 and putting a slight downward pressure on the load will cause the clutch disk 35 attached to the power spool 5 to rotate counterclockwise, which will allow the clutch spring 39 to push and rotate the clutch arm 36 back against the clutch disc 35 with the tapered pads returned, such that their low ends are just touching, thereby allowing the normal lift action to proceed.

### Swing Arms

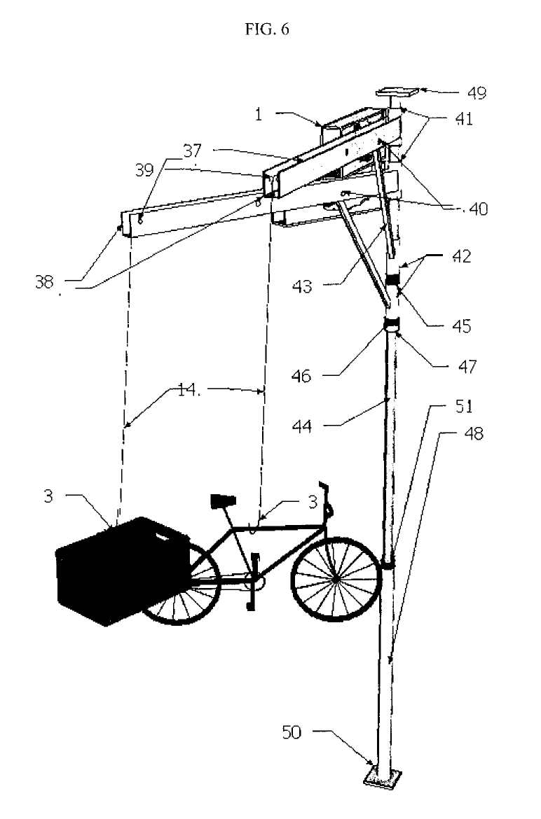

To facilitate storage in locations which may be crowded with other objects, such as in a garage, the counter torque mechanism 1 shown in FIG. 1 may be mounted on movable swing arms 37, 38 as shown in FIG. 6. The swing arms 37, 38 shown in FIG. 6 may rotate in any direction with the load attached, or not, to facilitate the placement of the loads in a convenient location when they are stored and or for loading and unloading of the object load, such as a bicycle. The two swing arms consist of a channel or tubular sections 38 to which are affixed the pulleys 39, 40, which guide the lift cable 4. Each swing arm has two hinge sections 44, 45. One is affixed to the end perpendicular to the horizontal section of the arm 39 oriented vertically and one attached to a brace 44 which extends from a point along the horizontal section of the swing arm 37 to the second hinge tube section 42, which is spaced a distance below the horizontal swing arm section 37. The second hinge section 42 is affixed with its axis aligned along the axis of the upper hinge section 41. The tubular hinge sections 40, 41 have a diameter slightly larger than the vertical support shaft 44. These hinge tubes are positioned concentrically over the vertical support shaft 44, such that they can pivot freely about the vertical support shaft 42. The two swing arms 37, 38 are interspersed on the vertical support shaft 44 as shown in FIG. 5. A bushing 45 is positioned between the two lower hinge tubes of each swing arm, such that the lower edge of hinge tube 42 of the uppermost swing arm 37 rest on the top edge of bushing 45. A second bushing 46 is placed below the lower most hinge section of swing arm 42. The bottom edge of the lower hinge tube of swing arm 40 rests on this bushing 46. Below this a locking bracket 47 is affixed to the vertical support shaft 44. The weight of the swing arms and their load are supported by this locking bracket 47. The swing arms 37, 38 rotate freely about their tube hinges on the bushings 45, 46. The swing arm assembly consists of six main components, the vertical support shaft 44, the swing arms 37, 38, the pulleys 39, 40, in FIG. 3 and the constant torque spring mechanism 1 shown in FIG. 1, the load cables 4 and the load hook 3. The vertical support 44 in FIG. 6 is the main support of the device. It has four main components to it, a vertical support shaft 44, a height adjusting shaft 48, a top plate 49, and a bottom plate 50. The main support shaft 44 is a cylindrical hollow tubular shaft, which is used in conjunction with the height adjustment shaft 48 to span the space between the floor and ceiling. The combined shafts comprise the load bearing support of the device. The support shaft 44 and the adjustment shaft 48, are in sections fastened together to form the desired length for a particular installation. These sections provide a more compact form factor for shipping of the device. The vertical support shaft 44 is held in place by the adjustment shaft 48 at the bottom of the vertical shaft 44, which is concentric with it. The height adjusting shaft 48 is slid to a position on the main shaft such that it and the main shaft 44 span the distance between the ceiling and the floor. Their combined length pinches them between the ceiling and the floor, holding them securely in place and supporting the total weight of the device the load attached (bicycle) to the load hook, when in operation, without any load bearing attachment to the walls, ceiling or floor. The height adjustment shaft 48 is a tubular hollow shaft with the same shape as the vertical support shaft 44 but slightly larger or smaller in cross section than the vertical support shaft 44. The height adjustment shaft 48 is fitted concentrically around the vertical support shaft 44, either inside of it or outside of it. During device installation the height adjustment shaft, which is a fraction of the length of the main shaft, is slid along the main vertical support shaft 44 with its stop bracket 51 loosened, such that the height adjustment shaft slides freely along the main shaft, allowing it to adjust the combined height to span the ceiling to floor distance. The combined length of the main shaft and height adjustment shaft are adjusted to cause the top plate 49 to press against the ceiling, while lower end bottom plate 50 of the height adjustment shaft 48 is pressed securely against the floor. The stop bracket 51 has two halves hinged together at one end. The other end has a bolt which passes through it. It is constructed such that when the bolt is tightened the bracket will tighten around the vertical support shaft 44 when shaft 44 is smaller than shaft 48 or around height adjustment shaft 48) when it is smaller than vertical support shaft 44, which prevents the adjustment shaft 48 from sliding with respect to the vertical support shaft 44, thereby fixing the combined length of the shafts, pinching the device between the ceiling and the floor. The bottom plate 50 has an adjuster in it to further allow the support shaft to be firmly pinched between the ceiling and the floor, with the stop bracket 51 tightened against the vertical support shaft it maintains the combined length of the two shafts, which thereby provides the load bearing support for the device, and load.

Alternatively for installations in which there is not a flat ceiling such as an open joists and rafter garage the main support shaft 44 is affixed to a convenient garage joist or rafter by a clamp. For these ceilings in which the joists and rafters are exposed, an alternate to pinching the vertical support shaft 44 between the ceiling and the floor is to secure the vertical support shaft 44 to a joist or rafter with clamps in a position near the end of its length. In this application the height adjusting shaft 48 is adjusted to extend the vertical support shaft up into the joist area, the height is adjusted as described for a sheet rocked enclosed flat ceiling installation but adjusted to achieve a mounting location to a joist or rafter were the clamp can be applied rather than pinched between floor and ceiling as described earlier. This alternate mounting then allows additional height for the load or bicycle to be raised up into the space between the joists, thereby creating additional headroom, below the stored objects such as bicycle(s) to allow unimpeded passage beneath them. The swing arms 37, 38 can be positioned such that two bicycles may be stored between the ceiling joists in this manner.

Alternately the constant torque mechanism 1 as shown in FIG. 1 with all other aspects the same as the preferred embodiment can be affixed directly to the ceiling joist(s) with a bar 50 to bridge the distance between two joists as shown in FIG. 1 to provide the entire load bearing support, for the mechanism and load (bicycles), with no swing arms or vertical support shafts. Another alternate, is to bolt the constant force mechanism, to a ceiling joist, in either an exposed joist ceiling or a flat sheet rocked ceiling with bolts suitable to carry the combined load of the constant torque mechanism 1 and the intended load using the bar 52 affixed to the top of the constant force mechanism 1 and then bolted to the ceiling joist. This can be done by mounting along the joists length or spanning two joists. In these cases multiple constant torque mechanisms 1 as shown in FIG. 1 can be independently mounted, as separate lifting mechanisms, for as many loads as desired.

### Horizontal Bicycle Storage

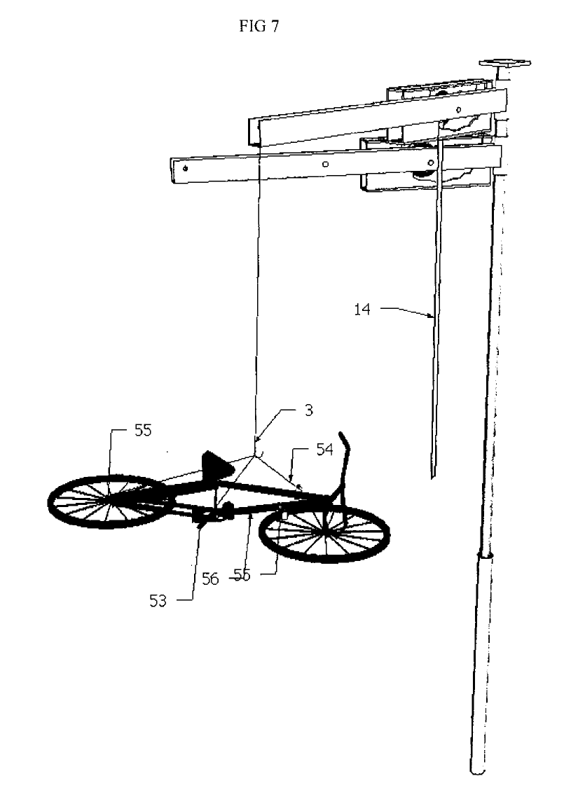

To provide additional headroom for the storage of a bicycle when it is in its raised position, the bicycle may be attached to an alternative mooring apparatus, which allows the bicycle to be stored horizontally. The horizontal storage apparatus provides three mooring cables, as shown in FIG. 7 attached at one end to the load hook 3, the other end of which are attached to points on the bicycle. The harness attaches to two fixed brackets, which are mounted to the bicycle in the appropriate positions and the third may use the bicycle load hook 3 described below or a third a fixed attachment point. The three attachment locations are; one at the pedal crank 53 area, one at the rear frame area 55 in proximity to the rear axle, and one on the bicycle cross bar 54, as shown in FIG. 4. “J” shaped hooks, at the end of each mooring line, attach to the fixed brackets on the bicycle. The brackets, which are affixed to the bicycle, are suitably covered in a soft material to prevent scratching or other damage to the bicycle. In operation after attaching the lift harness to the three points, the bicycle is allowed to lean into a near horizontal position, and the user then pulls the release cord 14, which causes the bicycle to rise to the desired storage height. The alternate release mechanism and or the auto release mechanism may also be used in the horizontal bike lift configuration. The attachment points are positioned such that, as the bicycle is raised, the bicycle will be tipped to a nearly horizontal position, but with a slight tilt toward the rear of the bicycle, such that it remains balanced between the three support attachment points. Storing the bike in this near horizontal position provides greater space between it and the floor thereby providing greater headroom, than in the case where the bicycle is held vertically. To prevent the front wheel from rotating about the steering axis when it is lifted in the near horizontal orientation, a storage strap 55 is affixed between the front wheel and the frame member 56. It holds the front bicycle wheel such that it is maintained in approximately the same plane as the frame, during lifting and storage. This strap 57 may be similarly attached for vertical orientation storage, as shown in FIG. 1 to prevents the front wheel from turning during lifting and storage and thereby provide a more compact profile for storage.

### Bike Load Hook

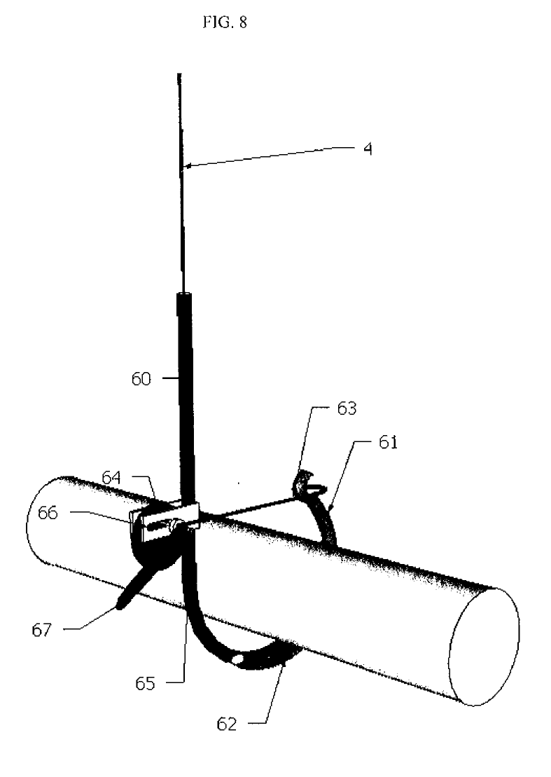

The load hook 3 in FIG. 1 secures the load (bicycle) to the device for lifting. Since bicycles may have different shapes and angles of their top frame member, the load hook must accommodate them. In particular for top frame members which are not, nearly horizontal, the load hook must be attached such that, the load hook 3 does not slide along the top frame member to which it is attached. FIG. 8 illustrates the special bike load hook for bicycles. The bicycle load hook is comprised of a the main body 60, an adjustable clamping portion 61, which is hinged to the main body 60 with a hinge pin 62, a latch lever 63 and a tightening cam 64. The portion 60 is affixed to the lift cable 4. A bicycle is placed on the “J” shaped main portion of the bicycle load hook 60 with latch lever 63 opened. With the bicycle is resting on the bottom of the “J” shaped portion 60 of the bicycle load hook 59, the clamping portion 60 is rotated around the cross bar of the bicycle and the latch lever 63 is engaged around the end of the clamping portion 61 as shown in FIG. 5. The tightening cam 64 is rotated about pin 65 in slot 66 with handle 67 to pull the clamp portion 61 around the bicycle cross frame, with the latch lever 63, which tightens and secures the clamp portion 61 around the bicycle frame member. The load hook portions 60, 61 are covered with a high friction soft material such that it slightly compresses as the tightening cam 64 is tightens the clamping portion 61 to securely hold the bicycle without damaging or scratching it.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention

What is claimed is:

1. An overhead storage device having a lifting range, said device comprising:
A) a power pulley;
B) a constant torque spring attached to the power pulley and adapted to apply an approximately constant torque to the power pulley;
C) a cable partially wound around the power pulley and having an attachment mechanism at one end of the cable; and
D) a locking mechanism adapted to permit the attachment mechanism and an attached load to be lowered and locked at any desired position within the range of the device;
wherein the approximately constant torque applied by the constant torque spring continuously causes the cable, unless restrained, to be further wound on the power pulley.

2. The overhead storage device as in claim 1, wherein said locking mechanism is a pawl and ratchet unit.

3. The overhead storage device as in claim 2, wherein said pawl and ratchet unit comprises a release cord connected to said pawl, wherein said pawl and ratchet unit restrains rotation of said spool unless said release cord has been pulled downward with a downward force.

4. The overhead storage device as in claim 1, wherein said constant torque spring comprises:
A. a spring,
B. an output spool, and
C. an input spool,
wherein said spring is wrapped around said output spool and said input spool in reverse directions so as to create a nearly constant torque on said output spool and said power pulley.

5. The overhead storage device as in claim 1, further comprising a means for holding said locking mechanism in an unlocked position while said cable is wound around said power pulley and while a load is raised.

6. The overhead storage device as in claim 1, further comprising an automatic load release means for allowing the raising and lowering of a load.

7. The overhead storage device as in claim 1, further comprising a centrifugal clutch for stopping rotation of said power pulley during rapid acceleration of said power pulley.

8. The overhead storage device as in claim 1 further comprising at least one swing arm, wherein said overhead storage device is mounted to said at least one swing arm, wherein said at least one swing arm may be positioned as desired by an operator.

9. The overhead storage device as in claim 8, wherein said at least one swing arm is at least two swing arms.

10. The overhead storage device as in claim 1, wherein said power pulley is utilized to raise a bicycle.

11. The overhead storage device as in claim 10, wherein said bicycle is horizontally attached to said cable.

12. The overhead storage device as in claim 1 wherein said attachment mechanism is a bike load hook.
